(19) United States
(12) Patent Application Publication
(10) Pub. No.: US 2023/0259957 A1
(43) Pub. Date: Aug. 17, 2023

(54) GUEST MESSAGING PLATFORM

(71) Applicant: Target Brands, Inc., Minneapolis, MN (US)

(72) Inventors: RAM MULAY, Andover, MN (US); MARITA BUERGE, Shoreview, MN (US); SUMIT SOOD, Minneapolis, MN (US); SHANKARANARAYANAN GOPALAKRISHNAN, Osseo, MN (US); SOHAM DESAI, Eden Prairie, MN (US)

(21) Appl. No.: 17/669,852

(22) Filed: Feb. 11, 2022

(51) Int. Cl. G06Q 30/02; H04L 51/046

(52) U.S. Cl. CPC G06Q 30/0201; G06Q 30/0204; G06Q 30/0242; G06Q 30/0261; H04L 51/046

(57) ABSTRACT

A platform for customer and prospective customer messaging is provided. The platform generally coordinates message audience selection, message timing, and message content for delivery on any of a variety of communication channels (e.g., email, text message, push notification) for messages from marketing tenants and operational tenants to ensure a coordinated customer experience.

### BACKGROUND

A business may communicate with its customers, or prospective customers (collectively referred to herein as guests or a target audience) by sending messages. These messages may be sent over different channels, such as email, text, telephone voice messages, push notifications, mail, or through an application. The messages may fall into different categories, such as marketing communications or operational messages regarding a specific guest, account, or order. Some of the messages may be directed to multiple guests (for example, a promotional offer), and others to a single guest (for example, a notification that an order is ready for pickup).

A guest may receive multiple messages of the same or different types from a business, at the same or different times, on one or multiple channels. A guest's satisfaction with a business's communications can have an important impact on the guest's satisfaction with the business overall, and thus on the business's reputation and ability to keep and attract guests. For example, a guest may be pleased with messages from the business regarding their personal accounts and orders that come through on a channel that they frequently use. A guest also may appreciate marketing messages tailored to their past shopping experiences. Conversely, for example, a guest may become frustrated with a message that alerts them that a guest order is ready for pickup during hours when the store is closed and pickup is not possible. A guest may become irritated if they receive repetitive messages of the same content, or a large enough number of communications in a short time that the messages become a nuisance.

Existing efforts to communicate with guests often utilize separate systems for communicating, e.g., operational messages and marketing communications. Additionally, separate systems may be utilized, in some instances, for communication with guests using different communication channels, even for marketing messages (e.g., an application messaging system for in-app messaging, a separate email messaging coordination system for email messages, etc.) While this was not typically considered problematic because each channel and type of message was largely independent of the others, however, it may nevertheless have a negative effect on an overall experience between a business and those guests.

### SUMMARY

The present disclosure describes systems and methods for delivering targeted and relevant messages to guests at times and over channels that will drive long-term guest satisfaction and business engagement. In some examples, a coordinated guest messaging platform may be implemented. In use, an event triggers a message to be sent to one or more guests. The message may be a marketing message or operational message. A marketing message may be triggered by an event from a marketing tenant, such as an audience services tenant, marketing campaign tenant, or business unit campaign tenant. An operational message may be triggered by an event from an operational tenant system.

The target audience for a message may need to be determined. The rules for determining the audience may be based on a number of factors, such as which marketing or operational tenant originated the triggering event, is there a category or brand associated with the message; whether the message is applicable to multiple guests; whether the message is associated with actions, purchases, or browsing history of a particular guest; or whether the message is applicable to a subset of guests (for example, owners of a registry, credit card, or rewards program). Additionally, factors may be considered such as reducing duplicate messages that a particular guest or subset of guests may receive and consolidating messages to send multiple messages to guests in the same delivery.

A determination must also be made as to which channel should be used to deliver the message. For example, a message may be delivered by channels such as email, text, telephone voice messages, push notifications, mail, or through an application. Factors considered to make this determination may include how many guests are included in the target audience, whether the message has any attachments, whether the message requires a guest response, whether the message is related to any other messages that have been sent by a particular channel, a particular guest's individual channel preference or past channel use, and whether the guest can access a particular channel. In some examples, if a message is being sent to multiple guests, one or more guests may receive the message on a different channel than other guests.

In some examples, a message is delivered to its target audience as soon as the audience, message type, and delivery channel are determined. In other examples, the message is held and sent to the target audience at a different time. The time at which the message is delivered may be determined based on factors such as whether the message is time-sensitive (for example, a promotional sale which lasts only a certain number of days); whether the message relates to store, pharmacy, pickup, or delivery hours of operation; and whether the message requires a responsive action of the target audience, among other possible factors. In some instances, a timing and prioritization of a message may depend on whether other messages are being sent to the same user, and message content, messaging channel, message delivery timing, or other aspects of a given message may be adjusted to optimize a guest business interaction experience.

In a first example aspect, a method includes receiving a plurality of messages for delivery from a plurality of tenants, including marketing tenants and operational tenants, the plurality of messages including marketing messages and operational messages. The method further includes determining an audience to whom to deliver one or more messages of the plurality of messages via an audience decisioning system, the determination of the audience being conditional, at least in part, on the one or more messages being a marketing message or an operational message, the audience including one or more recipients. The method also includes determining one or more channels by which to deliver the one or more messages to each recipient within the audience via a channel decisioning system, the channel decisioning system selecting the one or more channels based, at least in part, on an interaction of a determined audience. The method further includes determining a message delivery strategy associated with the one or more messages, via a message decisioning system, the message decisioning system generating the message delivery strategy based, at least in part, on one or more message delivery impact criteria. The method also includes building message files associated with each of the one or more messages via a message builder system, the message builder system generating the message files based, at least in part, on a determined channel, and delivering the one or more messages via a message delivery services system according to the one or more determined channels at an appropriate time.

In a further example aspect, a system is disclosed that includes a plurality of tenants, including marketing tenants and operational tenants, operating on a computing system. The system further includes a common communication platform operating on the computing system that receives data associated with a message from the plurality of tenants. The common communication platform includes an audience decisioning system operating on the computing system, the audience decisioning system in communication with the plurality of tenants, and a channel decisioning system operating on the computing system, the channel decisioning system having access to interaction information associated with one or more guests, wherein the one or more guests are associated with an audience. The common communication platform further includes a message decisioning system operating on the computing system, the message decisioning system being in communication with a content services system, and a message builder system operating on the computing system, the message builder system receiving information from the message decisioning system and a message delivery services system. The common communication platform further includes a message delivery services system operating on the computing system, wherein the message delivery services system has access to engagement information of the one or more guests and is configured to deliver the message to the audience via a channel determined by the channel decisioning system.

In a still further aspect, a system is disclosed that includes a processor and a memory coupled to the processor. The memory stores instructions, that, when executed by the processor, perform operations, comprising: receiving a plurality of messages for delivery from a plurality of tenants, including marketing tenants and operational tenants, the plurality of messages including marketing messages and operational messages; determining an audience to whom to deliver one or more messages of the plurality of messages, the determination of the audience being conditional, at least in part, on the one or more messages being a marketing message or an operational message, the audience including one or more recipients; determining one or more channels by which to deliver the one or more messages to each recipient within the audience, including selecting the one or more channels based, at least in part, on an interaction of a determined audience; determining a message delivery strategy associated with the one or more messages, the message delivery strategy being based, at least in part, on one or more message delivery impact criteria; building message files associated with each of the one or more messages based, at least in part, on a determined channel; and delivering the one or more messages via a message delivery services system according to the one or more determined channels at an appropriate time.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for sending marketing messages and operational messages to one or more recipients, according to an example.

FIG. 2 illustrates an example method in which a common communication process platform receives marketing messages and operational messages, makes determinations regarding message delivery, and provides them to one or more delivery channel systems for appropriate delivery, according to an example.

FIG. 3 illustrates an example system whereby a common communication process platform may receive marketing messages and operational messages, may make determinations regarding message delivery, and may provide them to one or more delivery channel systems for appropriate delivery, according to an example.

FIG. 4 illustrates the example system of FIG. 3, whereby a marketing tenant and operational tenant are in communication with an audience decisioning system, and the audience decisioning system may determine an audience for one or more messages, according to an example.

FIG. 5 illustrates the example system of FIG. 3, whereby a channel decisioning system may determine an appropriate channel by which to deliver one or more message, and a message decisioning system may determine a message delivery strategy, according to an example.

FIG. 6 illustrates the example system of FIG. 3, whereby a message builder system may build files associated with one or more messages, and a delivery services system may deliver the one or more message via a determined delivery channel, according to an example.

FIG. 7 illustrates an example of the example system of FIG. 3, whereby a common communication process platform comprises a guest interactivity optimization model, according to an example.

FIG. 8 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A business may communicate with its customers or guests by sending messages. These messages may be sent over different channels, such as email, text, telephone voice messages, push notifications, mail, or through an application. The messages may fall into different categories, such as marketing communications or operational messages regarding a specific guest, account, or order. Some of the messages may be directed to multiple guests, and others to a single guest. A guest may receive multiple messages of the same or different types from a business, at the same or different times, on one or multiple channels. A guest's satisfaction with a business's communications can have an important impact on the guest's satisfaction with the business overall, and thus on the business's reputation and ability to keep and attract guests

Given the fact that marketing messages and operational messages are both important for businesses to communicate and for guests to receive, it is beneficial if the correct messages are delivered to the correct recipient on the correct platform at the correct time. The delivered messages should efficiently communicate the subject matter of their content, and need to be delivered in such a way that the guest recipient can timely access the message and take any desired actions.

In current solutions, marketing messages and operational messages may not be managed together, but instead may be sent independently of each other. Marketing communications systems may generate messages and send them to one or more guest recipients. Additionally, marketing sub-systems may generate messages and send them to one or more guest recipients according to a variety of different communication channels, without correlation of timing or content across such multiple communication channels. Separately, operational tenants may generate messages and send them to one or more guest recipients. For example, one marketing sub-tenant may generate a message to all past shoppers regarding a particular sale weekend coming up and may send this first message by email. Then, another marketing sub-tenant may generate a message to all users of an application and may send this message via the application. Then, an operational tenant may generate a message to a single guest who made an online purchase that their purchase is ready for pickup in a store and may send this message via a text message. If the guest who made this purchase is also an application user and a past customer, this guest may receive all three of these communications, perhaps even in the same day. This may cause myriad problems, such as the guest becoming fatigued or frustrated by the multiple messages, the guest missing one of the messages because it was sent via a channel that is not their preferred channel, the guest receiving duplicate information (for example, if both of the messages from the marketing tenants included some of the same sale information), the guest receiving different marketing messages associated with the same campaign on different channels, or the guest receiving messages at an inappropriate time, among others.

Accordingly, the present application describes a system and methods for delivering targeted and relevant marketing messages and operational messages to guests at times and over channels that will drive long-term guest satisfaction and business engagement. The target audience for a message may be determined. A determination may also be made as to which channel should be used to deliver the message. For example, a message may be delivered by channels such as email, text, push notifications, or through an application. In some examples, if a message is being sent to multiple guests, one or more guests may receive the message on a different channel than other guests. Additionally, a message delivery strategy may be determined, including factors such as reducing duplicate messages that a particular guest or subset of guests may receive and consolidating messages to send multiple messages to guests in the same delivery. A message may be built that aligns with the message delivery strategy, the formats required by the determined channel, and the requirements of the determined audience. An appropriate time for message delivery may also be determined. In some examples, a message may be delivered to its target audience as soon as the audience, message type, and delivery channel are determined. In other examples, the message may be held and sent to the target audience at a different time. These and other examples will be explained in more detail below.

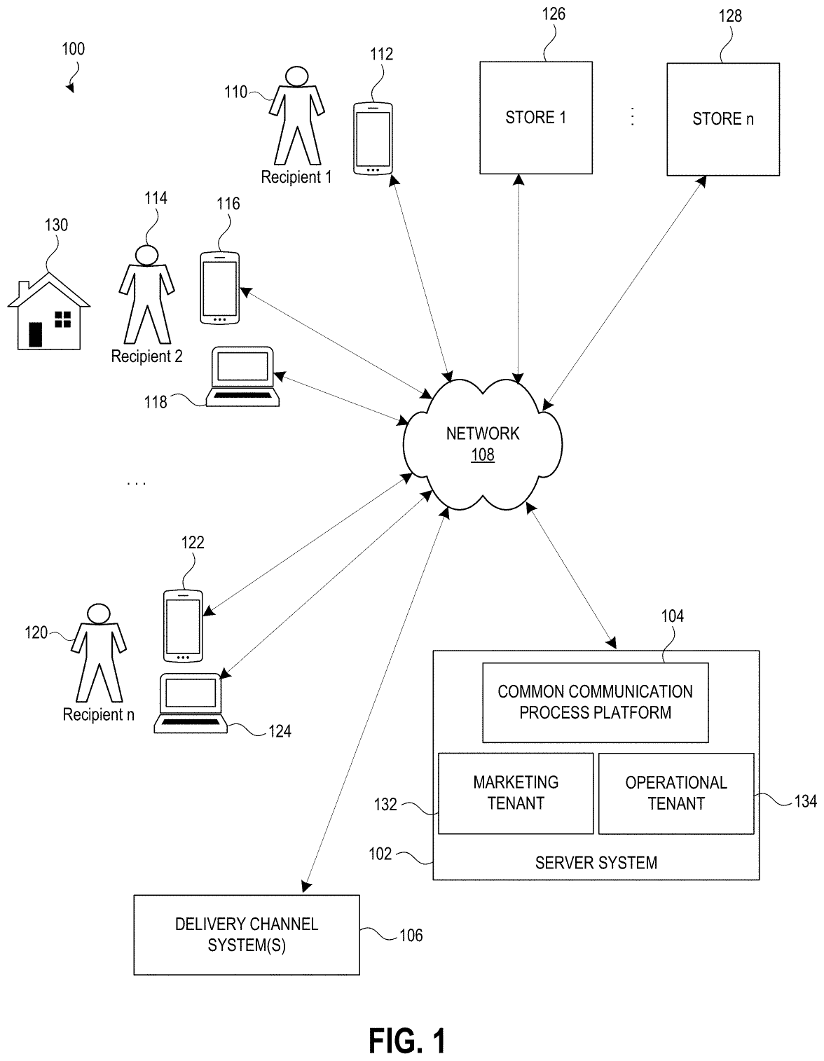

FIG. 1 illustrates an example system 100 for sending marketing messages and operational messages to one or more recipients. As will be described in more detail below, the system 100 includes a server system 102, which may include a common communication process platform 104, a marketing tenant 132 and an operational tenant 134. The system may also include a plurality of recipients, including: recipient 1 110, who may have a device such as a recipient 1 cell phone 112; recipient 2 114, who may have one or more devices such as a recipient 2 cell phone 116 and a recipient 2 computer 118; and recipient n 120, who may have devices such as a recipient n cell phone 122 and a recipient n computer 124. The system may also include one or more delivery channel system(s) 106 for the delivery of messages, a network 108, and one or more stores, store 1 126 through store n 128.

In an example, either the marketing tenant 132 or the operational tenant 134, or both, sends one or more messages to the common communication process platform 104 on the server system 102. In some examples, the server system may include one or more marketing tenants 132. In some examples, the server system may include one or more operational tenants 134. In some examples, the server system may provide an interface to which the marketing tenant 132 and/or operational tenant 134 may connect, e.g., via a communication application programming interface (“API”). Still further, in some instances, multiple marketing tenants and/or operational tenants may be communicatively connected to the server system 102. Example types of marketing tenants may include campaign-oriented tenants and triggered-activity tenants. A campaign-oriented marketing tenant may include a tenant configured to generate marketing email messages presenting marketing offers to a particular audience of one or more guests. A triggered-activity tenant may include a tenant configured to generate messages in response to detected guest activity, for example as tied to guest activity that may be detected from credit card usage activity, or from guest location as determined by a mobile application executing on a mobile device carried by that guest (e.g., the guest's position at a retail location triggering a particular offer). Other examples of campaign-oriented tenants and triggered-activity tenants are possible as well.

The common communication platform may communicate one or more messages via network 108 to one or more of the delivery channel systems 106. In some examples, network 108 may include a computer network, an enterprise intranet, the Internet, a LAN, a Wide Area Network (WAN), wireless transmission mediums, wired transmission mediums, other networks, and combinations thereof. Although network 108 is shown as a single network in FIG. 1, this is shown as an example and the various communications described herein may occur over the same network or a number of different networks. The one or more delivery channel systems 106 may communicate the message to the device(s) of one or more recipients, such as recipient 1 110, recipient 2 114, and recipient n 120, via the network 108. In some examples, delivery channel systems 106 may include text messages, in-application messages, push notifications, or emails. In some examples, the devices may include a smart phone such as recipient 1 cell phone 112, recipient 2 cell phone 116, or recipient n cell phone 122. In some examples, devices such as recipient 2 computer 118 or recipient n computer 124 may include a desktop or laptop computer. In some examples, devices to receive messages may include tablets, smart TVs, or smart wearable devices. In some examples, stores, such as store 1 126 through store n 128, are in communication with the server system 102 and/or communication process platform 104. In some examples, store 1 126 through store n 128 may be retail stores, grocery stores, supermarkets, franchise locations, discount retailers, department stores, wholesale stores, outlet stores, resale stores, convenience stores, pharmacies, chain stores, thrift shops, co-operative stores, or other stores where guests/customers may make purchases.

In a particular example, a marketing tenant 132 sends a message regarding a sale on a certain item sold in store 1 126 through store n 128 to common communication process platform 104, which determines that this message should be delivered to recipient 1 110, recipient 2 114, and other recipients. In an example, recipient 1 110 is inside of, or near, store 1 126. Common communication process platform 104 may determine that the appropriate one of the delivery channel systems 106 of the message to recipient 1 is through a text message sent to recipient 1 cell phone 112, because recipient 1 110 is near or in the store where they likely have their recipient 1 cell phone with them, will likely notice a text message on recipient 1 cell phone upon receipt of the message, and can then easily locate the sale item in store 1 126.

In a continuing example, recipient 2 114 is at or near their home 130. In some examples, home 130 may represent a workplace, social place, or other place that is not store 1 126 through store n 128. In an example where recipient 2 114 is at or near their home 130, common communication process platform 104 may determine that the appropriate one of the delivery channel systems 106 of the message to recipient 2 is through an email which will be received at recipient 2 cell phone 116 and recipient 2 computer 118, because recipient 2 114 may not be near store 1 126 through store n 128, may or may not have recipient 2 cell phone 116 on their person, may or may not have recipient 2 computer 118 on their person, and therefore sending the message via email may ensure that recipient 2 114 sees the message no matter which of their devices is nearest to them, or when the recipient may check his or her messages via that particular delivery channel. In an example, the message also needs to be send to other recipients, such as recipient n. Recipient n may be near a store, not near a store, have a recipient n cell phone 122, have a recipient n computer 124, another device, and various other factors which may impact how, when, and via which channel the message will be delivered to recipient n.

In a further example, an operational tenant 134 sends a message regarding an order placed by recipient 2 which is ready for pickup at store 1 126 to a common communication process platform 104. Common communication process platform 104 may determine that this order was placed by recipient 2 on a store application downloaded onto recipient 2 call phone 116, and may determine that the appropriate one of the delivery channel systems 106 via which to send the message is an in-application message. In an example, common communication process platform 104 may determine, using information from store 1 126, that the hours of operation of store 1 126 are 7:00 am to 8:00 pm, Mondays through Saturdays. Common communication process platform 104 may determine that the message should be sent to recipient 2 114 as an in-application notification to recipient 2 call phone 116 at 8:00 am on Monday morning, even if the message is generated by the operational tenant 134 outside of the hours of operation of store 1 126 (e.g., due to the preparation of the order being completed outside of regular store hours).

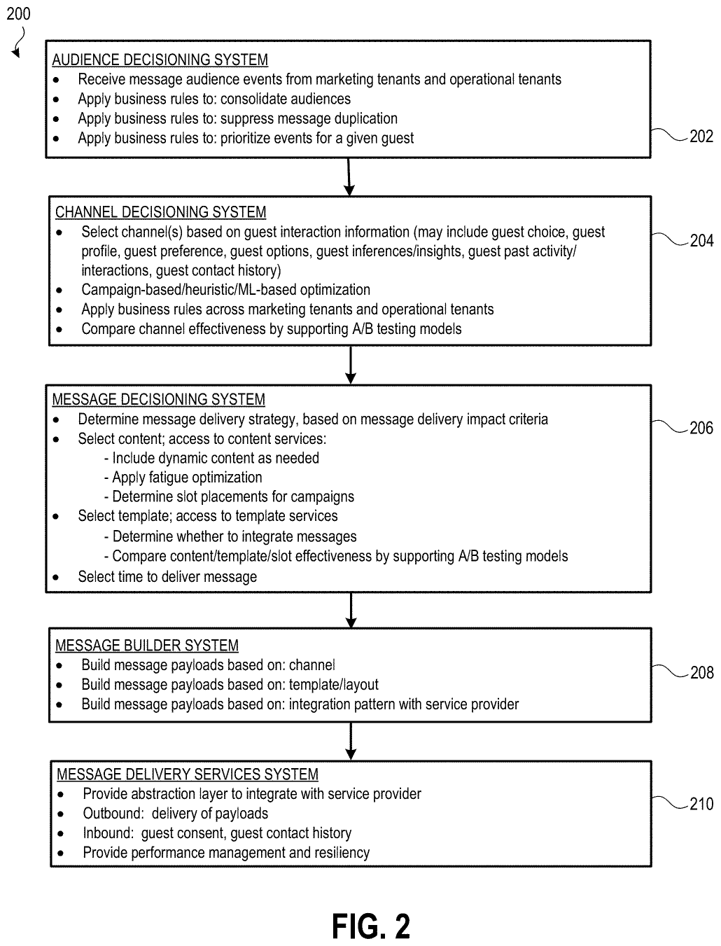

FIG. 2 illustrates an example method 200 in which a common communication process platform receives marketing messages and operational messages, makes determinations regarding message delivery, and provides them to one or more delivery channel systems for appropriate delivery, according to an example. The method 200 may be performed by one or more systems of the system 100 or the system 300 shown and described with respect to FIG. 1 and FIGS. 3-7.

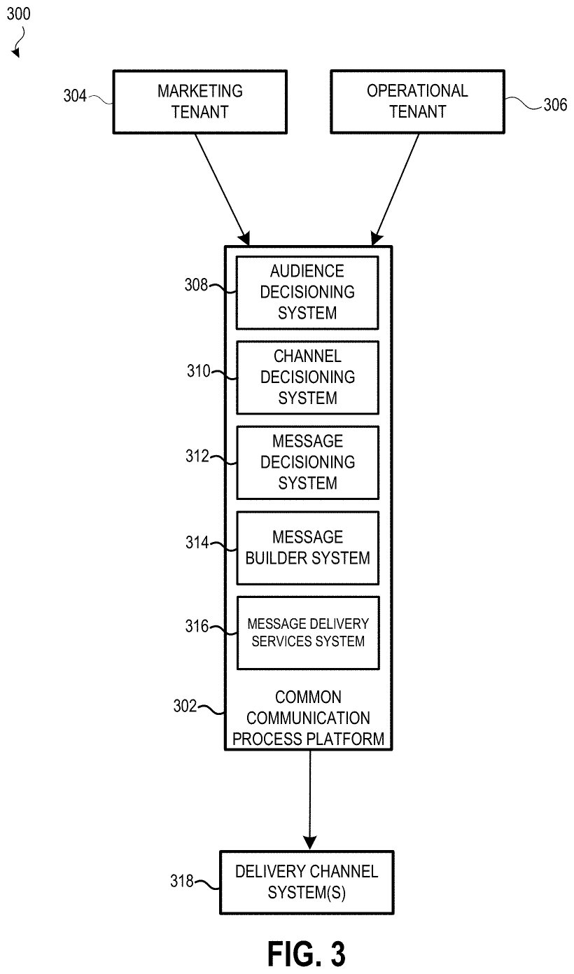

Method 200 begins with receiving one or more message audience events from at least one of a marketing tenant and an operational tenant, and determining an appropriate audience for the given message audience event (step 202). In the example shown, the message audience events may be received at an audience decisioning system, such as the audience decisioning system 308 described below in conjunction with FIGS. 3-7.

In an example, a message audience event comprises a message that needs to be sent to an audience. In some examples, an audience includes one recipient. In some examples, an audience includes more than one recipient. In some examples, the audience is associated with an order of a product or service. In some examples, the audience is a target of a marketing campaign. In some examples, the audience comprises past customers of a company or store. In some examples, the audience comprises a sub-group of store customers, for example, those customers holding a company credit card, those customers belonging to a rewards program, those customers having an online account with the store, or those who have downloaded an application associated with the store. In some examples, the message may be associated with a particular recipient or audience when it is received from the marketing or operational tenant, for example, a message that an order is ready for pickup may be associated with a particular store customer who placed the order. Similarly, a message that a customer has outstanding items in an online shopping cart which have not been purchased yet may be associated with the customer owner of the online account in who's online shopping cart the items are stored.

In step 202, the audience may need to be determined by the audience decisioning system. In some examples, the message relates to a marketing campaign or notification of a sale. The marketing campaign or sale notification may be more relevant to some customers than others. For example, if a particular sale is not legal in a state, then determining an appropriate audience for the message, at step 202, includes the audience decisioning system excluding customers in that state in its determined audience for the message. Similarly, if a product which is the subject of a sale or promotion is not available in a geographical area, then the audience decisioning system may not include customers in that geographical area in its determined audience for the message. In an example, a customer who has bout the same or similar product in the past, who has expressed interest in a particular product, or who has searched for the same or similar products online may be included in the audience for a message regarding sale, availability, or promotion of the product.

In determining the audience at step 202, the audience decisioning system may apply business rules to consolidate audiences. Business rules to consolidate audiences may include, for example, a rule to join audiences including customers made two different types of past purchases, or a combination of customers who made past purchases and therefore may be interested in a particular offer with other audiences of customers who may not have made past purchases, but have one or more other characteristics indicative of likely interest. Other types of audience consolidation business rules may be applied as well, and may vary according to the specific audiences or audience types to be consolidated.

In determining the audience at step 202, an audience decisioning system may apply business rules to suppress message duplication (that is, duplication of a message content which has previously been delivered to a recipient). In an example, a particular costumer may receive a message regarding an upcoming sale of a product as part of a communication targeted to rewards club members. Later, another message may be generated and provided to the audience decisioning system regarding the same sale of the same product as part of a general marketing communication. The audience decisioning system may determine not to include the particular customer in the audience for the second message, because they have already received communication regarding that sale of that product.

In determining the audience, business rules may be applied, for example by the audience decisioning system, to prioritize events for a particular recipient/guest. In an example, determining the audience to whom to deliver the one or more messages may be based, at least in part, on whether the content of messages applies to two or more recipients who are members of a particular business unit. In an example, a particular customer may have expressed a preference or desired priority for particular products or services, for example by indicating such preferences in an online account or by taking a survey. A preference or priority may also be inferred from past shopping, buying, and searching history of the customer. The audience decisioning system 202 may determine that this customer should be included in the audience for a message that is relevant to those particular products or services for which the customer has a preference.

A message may be sent via several different types of channels, for example, by email, text message, push notification, or in-application message. Accordingly, in the example embodiment shown, one or more channels may be selected for each individual included in the determined audience (step 204). The decision regarding what channel to employ for a given audience or each member of an audience may be performed, for example, by a channel decisioning system, such as described in conjunction with FIGS. 3-7, below. A channel may be determined, for example, based at least in part on customer/guest information, which may include customer choice (for example, a customer has indicated in an order process or in an online account that they have a preferred channel for receiving messages), customer profile (for example, a customer has indicated in an online account that they have a preferred channel for receiving messages), customer preference, customer options (for example, a customer has chosen a delivery channel during an order process or has opted into or out of email communications), customer inferences and insights (for example, customers of the same age and gender as a particular customer often efficiently receive messages sent by a particular channel), customer past activity and interactions (for example, in the past, a particular customer has purchased items after receiving messages pertaining to those items on a particular channel, or a particular guest has downloaded an application but has never interacted with the application after downloading it), and/or guest contact history.

A message may require an ability for the recipient to respond on the same channel as the message is delivered, and therefore step 204 may include the channel decisioning system selecting a channel over which a response is possible. For example, a customer may receive a message that an order is ready for pickup at a store, and which requires the customer to message back to the same message sender when they are outside of the store ready to pick up the order. In that example, the channel decisioning system may choose a channel such as a text message, which allows the customer to receive the text message and respond with a text on the same channel as necessary.

A message may require that the recipient take an action based on the message, for example, to pick up an order, to confirm a change to an online account, or to call a customer service number regarding an inquiry. Accordingly, in some embodiments, step 204 may include channel decisioning system determining to deliver the message via a channel which the intended recipient has chosen to be their preference for receiving messages or may determine to deliver the message via a channel which the intended recipient has interacted with or responded to in a recent timeframe (for example, interaction with an application in a recent timeframe or completion of actions prompted by push notifications in the past). Channel decisioning system may determine to deliver the message via a channel based, at least in part, on the content of previous messages sent to the determined audience via the same o

A message may be time sensitive. A time-sensitive message may require a response or an action by the recipient, as described below. A time-sensitive message may also pertain to message content which would be most beneficial to the recipient and/or the company sender if it was received at or before a specific time. In an example, a message may contain information regarding a sale of a set of products, the sale lasting for one weekend only. Accordingly, in some embodiments, the channel decisioning system may determine, for each member of the determine audience for the message, which channel is most likely to deliver the message in a manner whereby the recipient will see it before the start of the sale weekend. This determination may be done using customer information and/or other relevant factors and rules.

In example embodiments, step 204 may include determining an appropriate channel by which to deliver a message based, at least in part, on a location of an intended recipient and/or their devices. For example, a channel decisioning system may have access to location information from a mobile device (such as a cell phone, mobile phone, tablet, wearable device, or laptop computer) or may know a location provided by a customer in a customer profile. In an example, an intended recipient of a message which includes content regarding an ongoing sale or promotion of an item located in a store is inside of or near the store. The channel decisioning system may also determine that the appropriate channel is a text message sent to the intended recipient's cell phone, because they are near or in the store where they likely have their cell phone with them, will likely notice a text message on their cell phone upon receipt of the message, and can then easily locate the sale item that was the subject of the message in the store. In an example, intended recipient is at or near their home. Furthermore, the channel decisioning system may determine that the appropriate delivery channel of the message this intended recipient is through an email which will be received at their cell phone and computer (or any device they may access their email from), because the intended recipient may not be near a store, may or may not have their cell phone on their person, may or may not have their computer on their person, and therefore sending the message via email may ensure that the intended recipient sees the message no matter which of their devices is nearest to them.

In some examples, step 204 may also include applying business rules across both marketing tenants and operational tenants in order to determine the appropriate audiences for messages from both categories of tenants. For example, a channel decisioning system may apply campaign-based optimization, heuristic optimization, and/or machine learning-based optimization to effectively determine appropriate channels for given audiences and/or messages.

Channel decisioning system 204 may compare channel effectiveness and efficiency by supporting A/B testing models. For example, A/B tests may be employed to deliver different messages to different portions of a selected audience to assess the behavioral effects of delivery of such a message. In some instances, a channel decisioning system may be integrated with or in communication with an A/B testing platform such as is described in U.S. patent application Ser. No. 16/5176,877, entitled “Omnichannel Multivariate Testing Platform”, the disclosure of which is hereby incorporated by reference in its entirety.

In the example shown, the method 200 may further include determining a message delivery strategy, based at least in part on message delivery impact criteria (step 206). Determining a message delivery strategy may be performed, for example, by a message decisioning system, such as described below in conjunction with FIGS. 3-7. The message decisioning system may assess message delivery impact criteria and may select content, templates, layout, whether to integrate messages, delivery time, and other factors which may affect the impact that a message has on its recipient, or the efficiency of its delivery. In some examples, message delivery impact criteria may include customer/guest information, which may include customer choice, customer profile, customer preference, customer options, customer inferences and insights, customer past activity and interactions, and/or guest contact history. In some examples, message delivery impact criteria may be weighted, and message decisioning system 206 may rely more heavily on some criteria than others in making its message delivery strategy determinations.

In some examples, in step 206, a message decisioning system may select content to be included in a particular message. While the main content of the message may have been received from the marketing tenant or operational tenant that originated the message, the message decisioning system may optimize this content in some examples. In an example, the message decisioning system may include dynamic content in the message to be sent. In an example, the message decisioning system will apply fatigue optimization. In an example, the message decisioning system 206 may determine slot placements for campaigns, for example determining portions of time, portions of audiences, or portions of audiences in a given channel that may be configured to receive a given message.

In an example, step 206 may include the message decisioning system determining that a whether a first message and a second message with the same determined audience have similar content (and, in some examples, determining that the content similarity amounts to a duplication and that one of the messages need not be delivered). In an example, the message decisioning system may determine that multiple messages with different content which are assigned to the same audience (for example, messages from more than one marketing tenant, more than one operational tenant, a combination of marketing and operational tenants, or multiple messages from the same tenant) should be combined or integrated. For example, a particular customer may be determined to be the audience for a message from an operational tenant including a purchase receipt, as well as determined to be at least part of the audience for a message from a marketing tenant regarding the opening of a new store in an area near the particular customer's address. The message decisioning system may determine to integrate or combine the messages that have the same audience and which need to be delivered at around the same time. This may help ensure that the audience receives both messages efficiently and accurately and is not frustrated by receiving multiple messages from the same company.

In example embodiments, as part of step 206, the message decisioning system may determine the layout and visual characteristics of the message, including whether to use an available template from a template services system. Message decisioning system may also compare content, template, and slot effectiveness by supporting AB testing models in this stage.

Additionally, in some examples, the message decisioning system may determine appropriate, effective, or efficient time for a message to be delivered. Messages may be time-sensitive. A time-sensitive message may require a response or an action by the recipient. A time-sensitive message may pertain to message content which would be most beneficial to the recipient and/or the company sender if it was received at or before a specific time. In an example, a message may contain information regarding a sale starting on a particular day. The message decisioning system may determine a time for the message to be delivered prior to the start of the sale.

In some examples, a message may be delivered to the recipient as soon as it is ready for delivery. In other examples, a message delivery may be delayed until an appropriate time for delivery. In an example, a message may be delivered to a first recipient at a different time than a message of the same content is delivered to a second recipient. In an example, a message may be delivered during the operational hours of a store which is related to the content of the message (for example, a message from an operational tenant regarding a store order ready for pickup might have a determined delivery time equal to the opening time of the relevant store on the next business day). In an example, a message may be delivered at a time unlikely to cause frustration to the recipient (for example, a message delivered via push notification may be determined to be delivered during the day instead of at night when the recipient may be sleeping and a cell phone notification may be annoying

In some examples, messages to the same audience may be delivered at the same time (and may even be combined, as discussed above). In other examples, messages to the same audience may be delivered at different times. For example, a particular customer may be determined to be the audience for a message from an operational tenant that they have an order of perishable products available for pickup at a nearby store, as well as determined to be at least part of the audience for a message from a marketing tenant regarding the opening of a new store in an area near the particular customer's address. The message decisioning system may determine that the message regarding the perishable order should be sent to the particular customer as soon as possible, so that the customer can take action to pick up their products, and that the message from the marketing tenant may be sent at a later date at the same determined appropriate time as the customers who form the rest of the audience for that message.

In example embodiments, the method 200 may further include building a message file for delivery (step 208). Building the message file for delivery may be performed by a message builder system, as described further below in conjunction with FIGS. 3-7, and may include building a message file so that it may be adequately delivered in accordance with the determined audience and channel. That is, a message builder system may build message payloads/files based, at least in part on, the determined channel for delivery, the determined layout or template to be used (for example, a template from a template services system which was determined as appropriate by the message decisioning system), or an integration pattern with a service provider. In an example, a determined channel or necessary service provider has requirements or limitations that the message be in text format, data only format, partial HTML format, or full HTML format, and the message builder system may build the message file so that it comports with the requirements and is compatible with the determined channel or necessary service provider.

In example embodiments, the method 200 further includes delivering the message payloads/files to one or more determined delivery channel systems (step 210). Delivery channel systems may include text messaging, push notifications, in-application messages, or emails. In some examples, delivery of the message payloads/files may be performed by a message delivery services system, as described below. The message services system may provide an abstraction layer to integrate with a service provider (such as an internet service provider), for example, in a situation in which the message is being delivered via email.

In some examples, to deliver such message payloads or files, a message delivery services system may interact with guest engagement information, which may include guest profiles, guest interactions, guest insights and inferences, and guest contact history. For example, a message delivery service system may deliver new or changed information regarding guest consent to receiving messages (for example, receiving messages at all or on a certain channel) to the appropriate system within the guest engagement information. Additionally, the message delivery services system may provide performance management and resiliency, for example by receiving, tracking, and maintaining feedback regarding message deliveries to the selected audiences, and managing responses thereto.

FIG. 3 illustrates an example system 300 whereby a common communication process platform 302 may receive marketing messages and operational messages, may make determinations regarding message delivery, and may provide them to one or more delivery channel systems 318 for appropriate delivery, according to an example. As will be described in more detail below, the system 300 includes a common communication process platform 302, a marketing tenant 304, an operational tenant 306, an audience decisioning system 308, a channel decisioning system 310, a message decisioning system 312, a message builder system 314, a message delivery services system 316, and delivery channel systems 318.

Common communication process platform 302 may correspond to one example implementation of the common communication process platform 104 of FIG. 1, and may receive one or more marketing messages from a marketing tenant 304. In some examples, the common communication process platform 302 may receive one or more marketing messages from a plurality of marketing tenants 304 (examples of marketing tenants 132 of FIG. 1). In some examples, the marketing tenant 304 may include sub-tenants. Common communication process platform 302 may receive one or more operational messages from an operational tenant 306 (one example of operational tenant 134 of FIG. 1). In some examples, the common communication process platform 302 may receive one or more operational messages from a plurality of operational tenants 306. In some examples, the operational tenant 306 may include sub-tenants.

The marketing messages and operational messages may be received by an audience decisioning system 308. Audience decisioning system 308 functions to determine audiences to whom to deliver the marketing messages and operational messages. In an example, audience decisioning system 308 is within common communication process platform 302. In another example, audience decisioning system 308 is within marketing tenant 304. The audience decisioning system 308 may, in some examples, perform the processes described above in conjunction with step 202 of FIG. 2.

A channel decisioning system 310 within the common communication process platform 302 may receive the marketing messages, operational messages and the audience determination. Channel decisioning system 310 may function to determine an appropriate channel by which to deliver the message to the determined audience. In example embodiments, the channel decisioning system 310 may perform aspects of the processes described above in conjunction with step 204 of FIG. 2.

A message decisioning system 312 within the common communication process platform 302 may receive the marketing messages, operational messages, audience determination, and channel determination. Message decisioning system 312 may determine a message delivery strategy, based at least in part on message delivery impact criteria. In example embodiments, the message decisioning system 312 may perform aspects of the processes described above in conjunction with step 206 of FIG. 2.

A message builder system 314 within the common communication process platform 302 may receive the marketing messages, operational messages, audience determination, channel determination, and message delivery strategy. Message builder system 314 functions to build message files/payloads that satisfy determinations of the other systems within the common communication process platform 302, and which comport with requirements of delivery channel systems 318 and service providers. In example embodiments, the message builder system 314 may perform aspects of the processes described above in conjunction with step 208 of FIG. 2.

A message delivery services system 316 within the common communication process platform 302 may receive at least some of the marketing messages, operational messages, audience determination, channel determination, message delivery strategy, and built message files. Message delivery services system 316 may provide the message files to one or more determined delivery channel systems 318 to be delivered to the determined audience(s). In example embodiments, the message delivery services system 316 may perform aspects of the processes described above in conjunction with step 210 of FIG. 2.

In some examples, the functions performed by audience decisioning system 308, channel decisioning system 310, message decisioning system 312, message builder system 314, and message delivery services system 316 as described above may take place in the order they are shown and numbered in FIG. 3. In other examples, these functions may take place in an alternative order. In other examples, some, all, or portions of these functions may take place simultaneously.

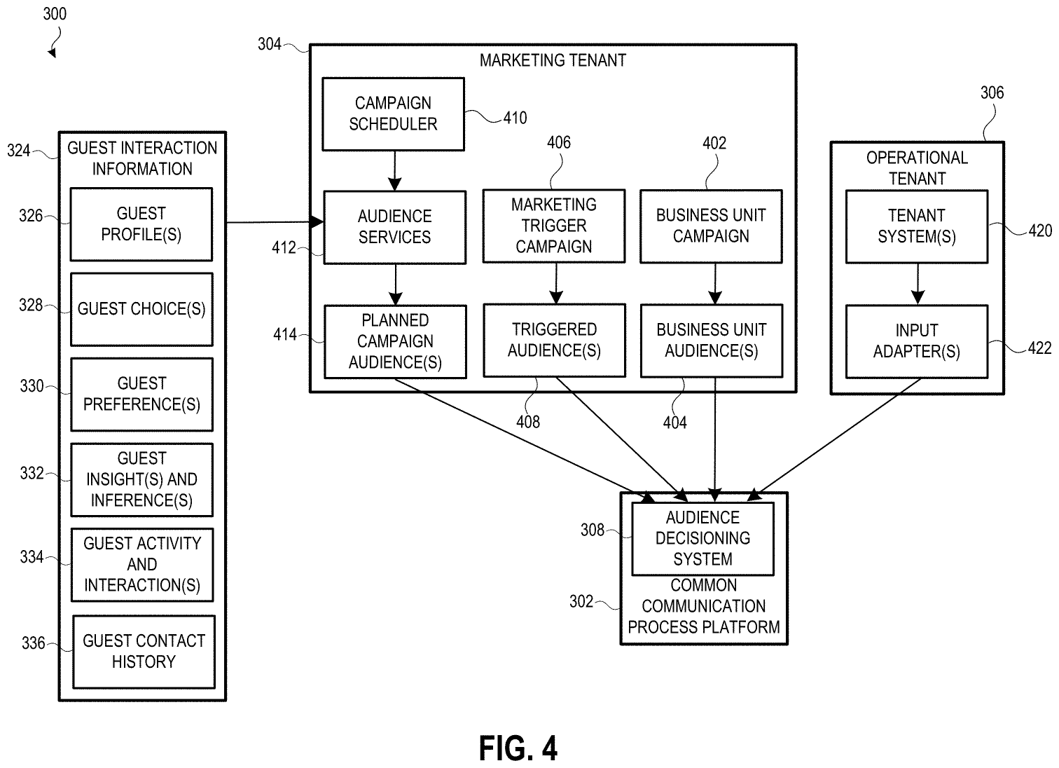

FIG. 4 illustrates a detailed view of system 300 of FIG. 3, whereby marketing tenant 304 and operational tenant 306 are in communication with audience decisioning system 308, and audience decisioning system 308 may determine an audience for one or more messages, according to an example. As will be described in more detail below, the system 300 comprises common communication process platform 302, marketing tenant 304, operational tenant 306, and guest interaction information 324.

In an example, marketing tenant 304 may include sub-tenants which may create or aid in the creation and origination of messages. In an example, sub-tenants may include a business unit campaign 402, which may be in communication with business unit audiences 404. In an example, marketing messages created by these sub-tenants may contain content related to specific sub-groups of customers/intended recipients, such as loyalty or credit card holders, registry members (for example, baby shower registries or wedding gift registries), users of an application, or users who have created an online account. Audience decisioning system 308 may receive a message from business unit audiences 404.

In an example, sub-tenants may include a marketing trigger campaign 406, which may be in communication with triggered audiences 408. In an example, marketing messages created by these sub-tenants may contain content related to customer activities or events such as abandoned products in an online shopping cart or browsing/search history for a particular good or service; these activities or events may trigger the creation of a message. Audience decisioning system 308 may receive a message from triggered audiences 408.

In an example, sub-tenants may include a campaign scheduler 410 which may generate or receive message audience events. Campaign scheduler 410 may be in communication with audience services 412, which may receive guest interaction information 324. Guest interaction information 324 may comprise any of: guest profiles 326, guest choices 328, guest preferences 330, guest insights and inferences 322, guest activity and interactions 334, and guest contact history 336. Audience services 412 may be in further contact with planned campaign audiences 414 to create marketing messages. In an example, marketing messages created by these sub-tenants may contain content related to a lifecycle, category, brand, or service. Audience decisioning system 308 may receive a message from planned campaign audiences 414.

In an example, operational tenant 306 may include sub-tenants which may create or aid in the creation and origination of messages. In an example, sub-tenants may include one or more tenant systems 420, which may be in communication with unput adapters 422. In an example, an operational event, such as a customer purchase, may trigger a message to be created which needs to be delivered. In an example, operational messages created by these sub-tenants may contain content related to customer orders, order pickups, order shipment, order payments, or customer inquiries. In an example, audience decisioning system 308 may receive a message from input adapters 422 or operational tenant 306. In another example, common communication process platform 302 or another system within common communication process platform 302 may receive a message from input adapters 422 or operational tenant 306.

Audience decisioning system 308 may determine one or more appropriate audiences to receive one or more marketing messages and operational messages.

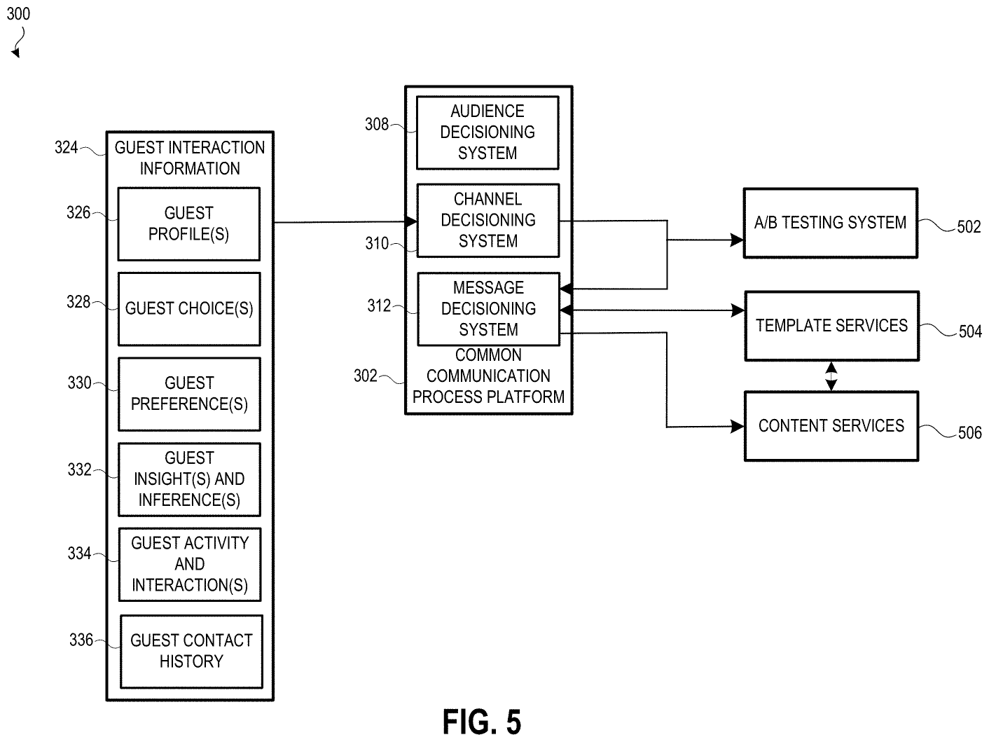

FIG. 5 further illustrates additional details of the example system 300 of FIG. 3, whereby channel decisioning system 310 may determine an appropriate channel by which to deliver one or more messages, and message decisioning system 312 may determine a message delivery strategy, according to an example. As will be described in more detail below, the system 300 comprises common communication process platform 302, audience decisioning system 308, channel decisioning system 310, message decisioning system 312, guest interaction information 324, A/B testing system 502, template services 504, and content services 506.

Channel decisioning system 310 may receive marketing messages, operational messages, and a determined audience for one or more of the messages from audience decisioning system 308. In some examples, audience decisioning system 308 is within common communication process platform 302. Channel decisioning system 310 may determine an appropriate channel by which to deliver one or more marketing messages and operational messages. In an example, in making its channel determinations, channel decisioning system 324 may receive guest interaction information 324. Guest interaction information 324 may comprise any of: guest profiles 326, guest choices 328, guest preferences 330, guest insights and inferences 322, guest activity and interactions 334, and guest contact history 336. In an example, channel decisioning system may further compare the effectiveness and efficiencies of different channels by supporting A/B testing models; in doing so, channel decisioning system 310 may be in communication with an A/B testing system 502.

In the example shown, message decisioning system 312 may receive marketing messages, operational messages, audience determination, and channel determination. Message decisioning system 312 may determine a message delivery strategy, based at least in part on message delivery impact criteria. In an example, message decisioning system 312 may compare effectiveness of delivery impact criteria determinations (for example, message content, templates, or slot placement) by supporting A/B testing and may be in communication with A/B testing system 502. In some examples, message decisioning system 312 may be in communication with template services 504 and content services 506, in order to aid in the determination of specific content and layout of content for one or more marketing messages and operational messages. In an example, template services 504 and content services 506 may be in further communication with each other.

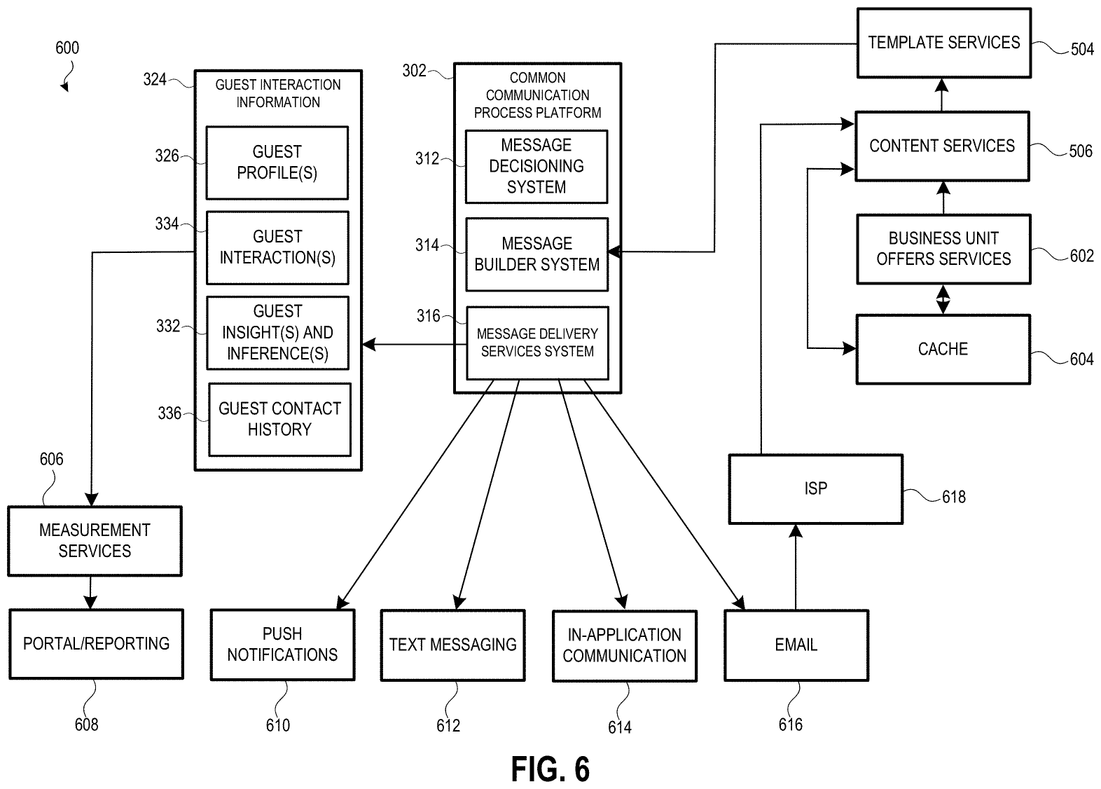

FIG. 6 further illustrates the example system 300 of FIG. 3, and in particular interactions between systems implemented for message building and delivery. In particular, message builder system 314 may build files associated with one or more messages, and message delivery services system 316 may deliver the one or more messages via a determined delivery channel, according to an example. As will be described in more detail below, the system 300 comprises common communication process platform 302, message decisioning system 312, message builder system 314, message delivery services system 316, as well as template services 504, content services 506, and use guest interaction information 324, as described above. The system 300 may also include business unit offers services 602, cache 604, measurement services 606, portal/reporting 608, push notifications 610, text messaging 612, in-application communication 614, email 616, and ISP (internet service provider) 618.

Message builder system 314 within the common communication process platform 302 may receive the marketing messages, operational messages, audience determination, channel determination, and message delivery strategy. Message builder system 314 may build message files that satisfy determinations of other systems within the common communication process platform 302, and which comport with requirements of delivery channel systems such as push notifications 610, text messaging 612, in-application communication 614, and email 616, as well as service providers such as ISP 618. In an example, message builder system 314 may receive information from template services 504, which it may use to help build messages if the message delivery strategy required the use of a template. In an example, the determined channel may have requirements or limitations as to the format of the message file, so that the message file must be in text format, data only format, partial HTML format, or full HTML format. In an example, a determined channel may accept message files in several of the aforementioned formats.

In an example, template services 504 may receive information from content services 506, which may be in communication with ISP 618. Template services 504 may also receive information from business unit offers services 602. In an example, business unit offers services 602 may may be in further communication with cache 604, which also may be in communication with content services 602. In operation, the template services 504 may provide one or more message templates into which business unit offers from the business unit offers services 602 are provided, as well as various content (e.g., graphics, text, etc.) from content services 506. Cache 604 may store previously-created messages and/or business unit offer information for integration into a selected template, for example for inclusion in content as separate messages or alongside messages to be delivered to particular audiences.

A message delivery services system 316 within the common communication process platform 302 may receive at least some of the marketing messages, operational messages, audience determination, channel determination, message delivery strategy, and built message files. In an example, message delivery services system 316 may send information to guest engagement information 352. Guest engagement information may include guest profiles 354, guest interactions 356, guest insights and inferences 358, and guest contact history 360. The guest profiles include account information of customers who have registered with the enterprise (e.g., by way of holding a credit card, or otherwise registering or creating an account with the retail enterprise). The guest interactions 356 may include information regarding various types of interactions, including online browsing history, interaction with specific items or item categories (e.g., via social media interactions), communications regarding orders exchanged with the guest, or other similar communications. The guest insights and inferences 358 may include inferences regarding possible characteristics of the guest, for example a family status, income or spend levels (e.g., average purchase amount), or other similar inferential information that may be determined from guest behavior. Guest contact history 360 may correspond to historical instances in which the guest is contacted, including, for example a time of contact, a channel of contact, and content or subject matter of the contact. Guest engagement information 352 may also be shared with measurement services 606, which may share information with portal/reporting 608.

In an example, message delivery services system 316 may provide the message files to one or more determined delivery channel systems to be delivered to the determined audience(s). In some examples, these delivery systems may include one or more of: push notifications 610, text messaging 612, in-application communication 614, and email 616. In an example, if a message file is to be delivered via email 616, it may be routed through ISP 618. ISP 618 may be in further communication with content services 506.

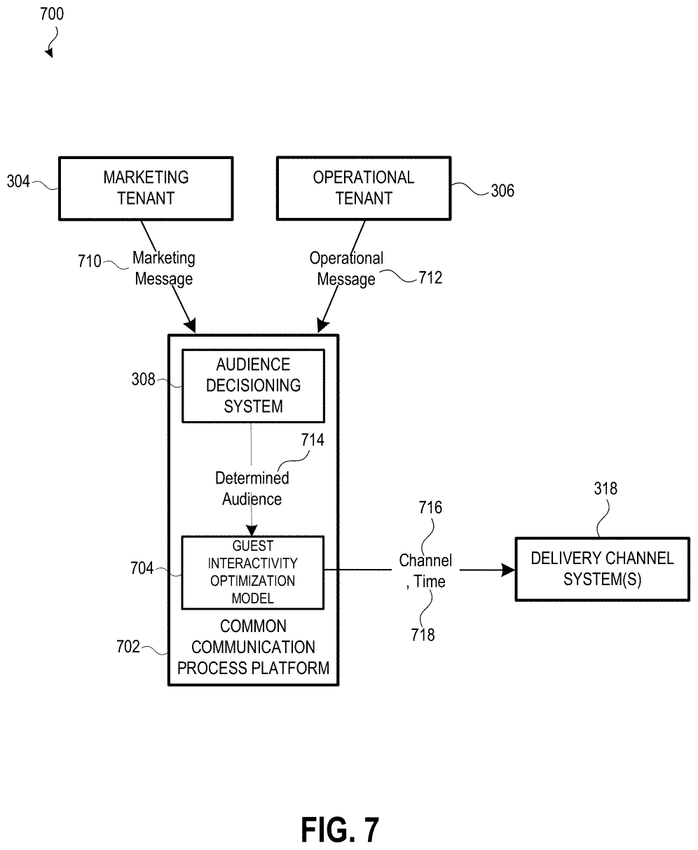

FIG. 7 illustrates a possible system 700, which illustrates a particular example of the system 300 of FIG. 3. In the example system 700 as shown, common communication process platform 702 (similar to common communication process platform 302 in other relevant aspects) further includes a guest interactivity optimization model 704. As will be described in more detail below, the system 700 comprises common communication process platform 702, marketing tenant 304, operational tenant 306, audience decisioning system 308, guest interactivity optimization model 704, and one or more delivery channel systems 322.

In an example, marketing tenant 304 may comprise one or more marketing sub-tenants. In an example, operational tenant 306 may comprise one or more operational sub-tenants. In some examples, marketing tenant 304, operational tenant 306, and common communication process platform 302 may be stored on the same server, while in other examples they may be stored on different servers. In an example, audience decisioning system 308 is located within common communication process platform 302. In other examples, audience decisioning system 308 is located within marketing tenant 304.

As previously described, a marketing tenant 304 may send a marketing message 710 to audience decisioning system 308. In an example, operational tenant 306 may send an operational message 712 to audience decisioning system 308. In an example, audience decisioning system 308 may determine a determined audience 714 to whom to send the marketing message 410 and the operational message 412. In an example, the choice of the determined audience 714 may be contingent on consolidation of content, suppression of duplicate content, guest priorities, and whether the message is from marketing tenant 404 or operational tenant 406, among other factors.

In an example, guest interactivity optimization model 704 may receive the determined audience 714 from audience decisioning system 308. In an example, guest interactivity optimization model 704 may determine an appropriate channel 716 by which to deliver the marketing message 710 and the operational message 712. The determination of the appropriate channel 716 may be contingent on factors such as guest interaction information, campaign-based optimization, business rules, among other factors. In an example, guest interactivity optimization model 704 may determine an appropriate time 718 at which to deliver the marketing message 710 and the operational message 712. The determination of the appropriate delivery time 718 may be contingent on whether the content is time-sensitive, the hours of a store, whether a response is required, and the determined channel, among other factors. In an example, guest interactivity optimization model 704 may determine an appropriate message delivery strategy by which to deliver the marketing message 710 and the operational message 712. The determination of the appropriate message delivery strategy may be contingent on message delivery impact criteria, which may include customer/guest information, which may include customer choice, customer profile, customer preference, customer options, customer inferences and insights, customer past activity and interactions, and/or guest contact history, among other factors. The guest interactivity optimization model 704 may, in some examples, build a message file for the marketing message 710 and the operational message 712 that aligns with the determinations previously discussed and that comports with requirements of the determined delivery channel 716 (for example, whether the file should be in text format, data only format, partial HTML format, or full HTML format). In some examples, the guest interactivity optimization model 704 may distribute the message files to the delivery channel system 318 of the determined channel 716, at the determined time 718. In some examples, the determinations discussed above may be made based, at least in part, on different weights associated with different factors that the determinations are contingent on.

In some examples, the guest interactivity optimization model 704 is an artificial intelligence engine. In other examples, the guest interactivity optimization model 704 is another system capable of machine learning. In some examples, the guest interactivity optimization model 704 is a model which was generated by an artificial intelligence engine. For example, a communication recommendation optimization model may utilize the guest interaction information, including guest choices, guest preferences, guest insights, guest activity and interactions, and guest contact history, to optimize expected interactivity with a given message. For example, the guest interactivity optimization model 704 may determine an appropriate channel for a message, as well as a format for the message, thereby generating recommendations for how the channel decisioning system 310, message decisioning system 312 would operate to determine a most appropriate delivery mechanism for the given audience. In some examples, the guest interactivity optimization model 704 may also provide recommendations regarding selection of, or modification of, the audience to whom the message should be delivered.

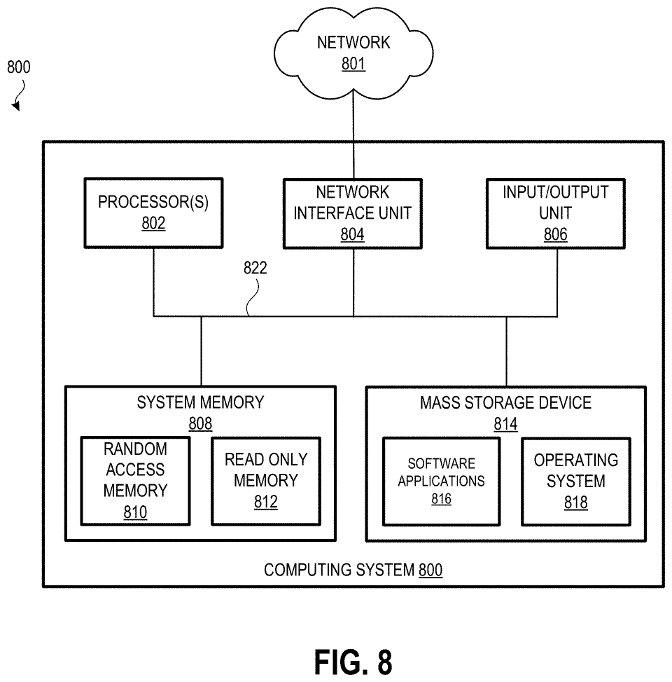

FIG. 8 illustrates an example block diagram of a virtual or physical computing system 800. One or more aspects of the computing system 800 can be used to implement the common communication process platform 104/302, store instructions described herein, and preform operations described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

Referring to FIGS. 1-8 overall, it is noted that the guest messaging platform described herein, and in particular the common communication process platform, provide particular advantages in terms of integration and coordination of customer (guest) messages. Specifically, the platform generally coordinates message audience selection, message timing, and message content for delivery on any of a variety of communication channels (e.g., email, text message, push notification) for messages from marketing tenants and operational tenants to ensure a coordinated customer experience, minimizing customer annoyance, and improving the likelihood of interactivity with a given message.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method, comprising:
receiving a plurality of messages for delivery from a plurality of tenants, including marketing tenants and operational tenants, the plurality of messages including marketing messages and operational messages;
determining an audience to whom to deliver one or more messages of the plurality of messages via an audience decisioning system, the determination of the audience being conditional, at least in part, on the one or more messages being a marketing message or an operational message, the audience including one or more recipients;
determining one or more channels by which to deliver the one or more messages to each recipient within the audience via a channel decisioning system, the channel decisioning system selecting the one or more channels based, at least in part, on an interaction of a determined audience;
determining a message delivery strategy associated with the one or more messages, via a message decisioning system, the message decisioning system generating the message delivery strategy based, at least in part, on one or more message delivery impact criteria;
building message files associated with each of the one or more messages via a message builder system, the message builder system generating the message files based, at least in part, on a determined channel; and
delivering the one or more messages via a message delivery services system according to the one or more determined channels at an appropriate time.

2. The method of claim 1, further comprising determining the appropriate time at which to deliver the one or more messages for at least some of the recipients in the audience, wherein the determination of the appropriate time is based, at least in part, on whether the one or more messages are time-sensitive.

3. The method of claim 2, wherein determining the appropriate time is based, at least in part, on whether the message requires a response from at least some of the recipients in the audience.

4. The method of claim 2, wherein the appropriate time includes a plurality of different appropriate times for different recipients within the audience, wherein the plurality of different appropriate times includes a first appropriate time for a first recipient and a second appropriate time for a second recipient.

5. The method of claim 2, wherein the appropriate time is determined based, at least in part, on the operational hours of a store.

6. The method of claim 2, wherein the appropriate time is determined via a message decisioning system.

7. The method of claim 1, wherein determining one or more channels by which to deliver the one or more messages is based, at least in part, on whether the one or more messages require a response from the determined audience.

8. The method of claim 1, wherein determining one or more channels by which to deliver the one or more messages is based, at least in part, on a preference of the determined audience.

9. The method of claim 1, wherein determining one or more channels by which to deliver the one or more messages is based, at least in part, on a content of previous messages sent to the determined audience.

10. The method of claim 1, wherein determining the audience to whom to deliver the one or more messages is based, at least in part, on whether a content of the one or more messages applies to two or more recipients who are members of a business unit.

11. The method of claim 1, wherein determining the audience to whom to deliver the one or more messages is based, at least in part, on whether the content of the one or more messages has previously been delivered to a recipient in the audience.

12. The method of claim 1, wherein determining a message delivery strategy associated with the one or more messages includes combining a first content of a first message of the one or more messages with a second content of a second message of the one or more messages.

13. The method of claim 1, wherein determining a message delivery strategy associated with the one or more messages comprises determining whether a first message of the one or more messages has a first content which is substantially similar to a second content of a second message, and wherein the determined audience of the first message is the same determined audience of the second message.

14. The method of claim 13, delivering the first message to the determined audience and cancelling the delivery of the second message to the determined audience, wherein the second message is one of the one or more messages.

15. The method of claim 13, cancelling the delivery of the first message, wherein the second message has been delivered to the determined audience.

16. The method of claim 1, wherein the message delivery impact criteria comprise one or more of the following: a content of the one or more messages, model templates, the appropriate time, the interaction of a determined audience, and the determined channel.

17. A system, comprising:
a processor; and
a memory coupled to the processor, the memory storing instructions, that, when executed by the processor, perform operations, comprising:
receiving a plurality of messages for delivery from a plurality of tenants, including marketing tenants and operational tenants, the plurality of messages including marketing messages and operational messages;
determining an audience to whom to deliver one or more messages of the plurality of messages, the determination of the audience being conditional, at least in part, on the one or more messages being a marketing message or an operational message, the audience including one or more recipients;
determining one or more channels by which to deliver the one or more messages to each recipient within the audience, including selecting the one or more channels based, at least in part, on an interaction of a determined audience;
determining a message delivery strategy associated with the one or more messages, the message delivery strategy being based, at least in part, on one or more message delivery impact criteria;
building message files associated with each of the one or more messages based, at least in part, on a determined channel; and
delivering the one or more messages via a message delivery services system according to the one or more determined channels at an appropriate time.

18. The system of claim 18, wherein the channel is selected from the group consisting of email, push notification, in-application messaging, and text messaging.

19. A system, comprising:
a plurality of tenants, including marketing tenants and operational tenants, operating on a computing system;
a common communication platform operating on the computing system that receives data associated with a message from the plurality of tenants, the common communication platform comprising:
an audience decisioning system operating on the computing system, the audience decisioning system in communication with the plurality of tenants;
a channel decisioning system operating on the computing system, the channel decisioning system having access to interaction information associated with one or more guests, wherein the one or more guests are associated with an audience;
a message decisioning system operating on the computing system, the message decisioning system being in communication with a content services system;
a message builder system operating on the computing system, the message builder system receiving information from the message decisioning system and a message delivery services system; and
the message delivery services system operating on the computing system, wherein the message delivery services system has access to engagement information of the one or more guests and is configured to deliver the message to the audience via a channel determined by the channel decisioning system.

20. The system of claim 19, wherein the common communication platform is in communication with one or more stores via a network.
